(19) United States
(12) Patent Application Publication
(10) Pub. No.: US 2011/0095494 A1
(43) Pub. Date: Apr. 28, 2011

(54) Hydraulic stabilizer

(76) Inventor: Dennis Joseph White, Plainsboro, NJ (US)

(21) Appl. No.: 12/589,662

(22) Filed: Oct. 27, 2009

(51) Int. Cl. B60G 21/073; B60G 17/056

(52) U.S. Cl. 280/5.509; 280/5.508

(57) ABSTRACT

A control system to stabilize horizontal motion of a vehicle under varying steering conditions. A turn to the right or left will cause the oil from one shock to be redirected, through tubing, to the opposite side shock, causing a matched suspension spring compression to occur on both sides of the vehicle. In a straight ahead course, the hydraulic cross-vehicle flow is aborted.

This invention was first disclosed in provisional application No. 61/129,074, but has since expired after one year, ending Jun. 3, 2009.

### FIELD OF INVENTION

This invention relates in general to movement control of motorized vehicles and specifically relates to a horizontal stabilizing system.

### DESCRIPTION OF THE PRIOR ART

The current day stabilizer bar levels the car, when turning, by matching compression of both right and left springs. If the spring is compressed on the right side, the stabilizer bar will transfer this energy, based on simple lever mechanical theory, and compress the spring on the left side. The matched compression heights of springs will tend to keep the car level when in a yaw or turning maneuver. This concept of using a sway bar for leveling a car is often applied to both front and rear suspensions. It is applied to automobiles, trucks, and trailers.

### OBJECTS AND ADVANTAGES

The stabilizer performs an efficient task of leveling a turning car. The disadvantage of the present day stabilizer bar, unfortunately, is that the stabilizer bar would tend to compress both springs simultaneously even when not needed, as in the case of an automobile driving in a straight ahead course. One such instance of this negative virtue is exhibited when the car hits a bump, on one side. Since the stabilizer bar matches spring compression bilaterally, both springs compress when hitting this one-sided bump. The sway bar will transfer shock absorbing energy to the opposite wheel. The impact of the bump is not readily absorbed as a fully independent suspension. The spring compression rate is essentially doubled. Thus, events occur, when compressing both springs, due to the connection with a stabilizer bar, may be undesirable.

This invention, a hydraulic stabilizer, takes the place of the traditional metal stabilizer bar.

The advantage of this disclosure is that stabilizing is effectively active while the vehicle is engaged in turning, and yet inactivated when steering straight ahead. Therefore, one-sided irregularities of the highway may be addressed with a fully independent suspension. The involved single spring will be more absorbent to shock than the shared two-spring response. The suspension is more forgiving, because each wheel travels independently when the vehicle is traveling straight forward. The main object of this invention is to deliver a more comfortable driving experience.

The concept of driving on a straight ahead course, with less influence from the stabilizer bar, has been the interest of many inventors. Fujimori, U.S. Pat. No. 7,270,336 and Drinan, U.S. Pat. No. 7,530,584 and Fulks, U.S. Pat. No. 6,554,305 all describe anti-roll bars. The inventors have recognized an important drawback in suspension design. Their disclosures are successful innovations. They also attempt to utilize a sway bar with different levels of activation to suite different driving conditions. However, they all share the disadvantage of the added weight of the bar itself, along with the extra weight of the controlling devices.

Transfer of energy is diminished, because of twisting in the sway bar itself. To counter this undesirable effect, performance bars are designed even heavier and thus will cause even more added weight. Some performance bars are over one inch in diameter.

The amount of combined weight of the components of this invention is lighter than the present day stabilizer bars. This new invention does not have the added linkage and bushings as used in today's stabilizer bar systems. Less weight would equate to better efficiency.

This disclosure could avail better leveling characteristics than a conventional sway bar. It is a positive displacement system, characteristic of fluid dynamics. Therefore, transfer of the necessary leveling energy is more efficient.

The present disclosure uses no external energy to deliver the anti-roll properties. The natural movement of the tilting, or rolling, of the car, provides the energy to compress the opposite cylinder and, thus, opposite side spring, to level the vehicle. There are no added energy demanding devices to further burden the vehicles fuel requirements. Most of the prior art require supplementary input of energy to operate level controlling devices.

Some designs rely on electric powered hydraulic systems, such as described by Stacey, et al., U.S. Pat. No. 7,475,895. Stacey's stabilizer, as well as many others, rely on energy sources to deliver hydraulic pressure. Similarly, Kindermann, et al., U.S. Pat. No. 5,066,041, uses hydraulic cylinders acted on by separate compressors.

### SUMMARY OF THE INVENTION

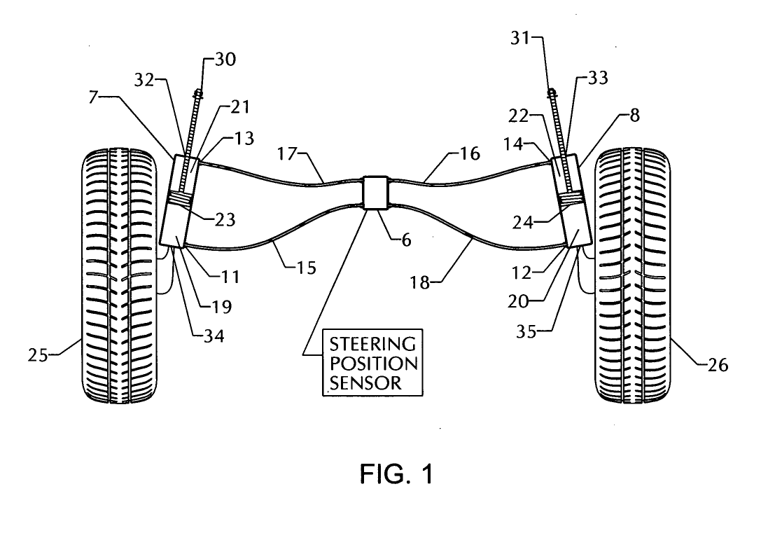

FIG. 1 shows left wheel 25 and right wheel 26. The cylinder 7 is attached at one end to the lower control arm 34. The cylinder 7 second end is supported by shaft guide 32. The left hydraulic cylinder 7 is divided into two chambers, lower chamber 19 and upper chamber 21, separated by a piston 23. The piston is pivotally connected to frame 30, guided through end of cylinder 7 and is in slidable, intimate contact with the inner walls of cylinder 7. The cylinder 7 moves, for the most part, vertically, in relation to frame, and in harmony with the wheel control arm 34 that it is attached to.

The right side cylinder 8, mirrors a similar mechanical arrangement, with a piston 24 creating two separate chambers, lower chamber 20 and upper chamber 22. The piston 24 is pivotally anchored to vehicular frame 31. The cylinder 8 is pivotally anchored to the lower control arm 35 of the right wheel 26.

The hydraulic lines 15, 16, 17, and 18 interconnect through a control valve 6. The control valve 6 is set into function according to the position of the vehicular steering wheel. When traveling straight ahead, the control valve 6 recirculates hydraulic oil within the same cylinder, thus communicating lower and upper chambers within the same cylinder. Therefore, if the right wheel 26 hits a bump, the cylinder 8 moves upward. The relative position of the piston 24 is downward, into lower oil chamber 20 pushing oil through fitting 12 and into oil line 18. The oil travels into the control valve 6 and is directed into line 16 to the fitting 14 and back into the same cylinder 8, into the upper chamber 22.

The reverse travel of oil occurs when the right wheel 26 returns to normal position and oil is again passively distributed between chambers 20 and 22. That is, when the wheel position rebounds back, the oil returns through the oil line 16 to valve 6 and is directed back into chamber 20.

The steering position sensor regulates the setting for valve 6. At some predetermined setting of the steering wheel, perhaps five or ten degrees off center, the control valve 6 will direct the oil away from the wheel with the cylinder chamber that is decreasing in size. The control valve 6 will redirect this oil to the opposite chamber of the opposite cylinder. That is, if the car turns left, the car will tilt downward on the right side. Relative to the position of the cylinder, the piston 24 will travel downward, as the car leans to the right. The lean of the vehicular frame will cause the attachment point to frame 31 to force piston downward. Oil from the lower oil chamber 20 will travel through the fitting 12 and into the oil line 18. The control valve 6 will now direct this oil into line 17 through the fitting 13 and into the upper oil chamber 21 of the left cylinder 7. This oil pressure will tend to drive down the piston 23 and force oil from the lower oil chamber 19 through the fitting 11 and into the oil line 15 and back to the control valve 6. The valve 6 redirects the oil back through line 16 and through the fitting 14 and into the top oil chamber 22 of the right cylinder 8. The downward movement of the right piston 24 from the initial left turn, also causes a negative pressure in the upper chamber 22 to help facilitate receiving of oil from the opposite lower oil chamber 19.

### CONCLUSIONS, RAMIFICATIONS AND SCOPE OF INVENTION

Thus, the car is maintained in a level orientation on turns, while keeping an independent wheel response to bumps on a straight course.

The described stabilizer could also be adapted to the rear suspension as well as the front. A single distribution valve, in union with the steering position sensor, could serve both front and rear suspensions.

A favorable use for this invention is to adapt present day shock absorbers to receive the necessary fittings and oil lines as described at length above. The shocks are already mounted in place to the vehicle. This invention could be applied to standard shock absorbers or to the McPherson type shock suspension.

The shocks in use today are already attached between the vehicular frame to either a lower or upper control arm or any other component relatively fixed to wheel mounting or wheel support member.

The inventor recognizes attention is needed to adjust the oil flow characteristics, which is normally addressed by the piston of a shock absorber. For example, many shocks contain valves. Valves allow oil passage to accommodate piston movement within the oil of the cylinder. The valve may be set for equal resistance for either shock compression or extension.

Conversely, the valve may be configured to allow greater flow in one favored piston movement direction over another. Depending on driver preferences, the piston valve may allow an easier compression of shock, but set with a higher resistance to extension, or visa versa.

Varying orifice sizes, within valve 6, would regulate the flow of oil to the same cylinder in the situation of a straight ahead bearing. This would avail the shock a damping action to wheel movement. Vertical movement damping is the original intended use for shock absorbers. To enhance operator experience, the orifices could be adjusted in the field with incorporation of adjustable valves, such as a needle valve.

Another ramification of this invention is to actually include a separate system of cylinders, dedicated solely to anti-roll. This would allow the present shocks and McPherson systems to operate as originally designed. The advantage to a second set of dedicated cylinders, would be an easier adaptation to current production and also be made available as aftermarket installation.

The control valve 6 could be of the type of hydraulic valving seen today in automatic transmissions. Thus, it could consist of a O-ring clad stem operating between drilled ports. The placement of ports in relation to the travel of O-ring separators controls direction of flow between the cylinders.

The valving could also be a rotational type. An example would be a kitchen faucet, with O-rings placed on a diagonal on the center, rotatable shaft. Rotating the shaft engages various port arrangements.

An additional tube could be directly attached to exit ports on the same shock, thereby reestablishing communication with upper and lower chambers of the same cylinder. Thus, a direct return line could be included in this patent design.

By directly connecting the two ports, the distribution valve 6 could be eliminated. As the vehicle strikes one sided bumps, the oil would automatically return to the same cylinder, via this now added direct return line, into the chamber on the opposite side of sliding piston. The positive pressure on the one side of piston is compensated by a negative pressure on the other side of piston.

In this described design of eliminating the distribution valve 6 a solenoid shutoff would be installed on the described direct return line between the ports on the same cylinder. Thus, in the event of a turn, at a predetermined angle, the solenoid valve would close. Oil would not be able to return to its own cylinder. In the instant of a closed direct return oil line, oil would then transfer to the piston assembly on the opposite side of car and cause a more controlled leveling.

Alternatively, in place of the direct return oil line, a piston may contain a valve, communicating the upper and lower chambers of the same cylinder. This valve may be activated open or closed depending of the driving control preferences. One example of this design is disclosed by Jensen, et al., U.S. Pat. No. 5,749,596.

I claim:

1. A vehicular hydraulic stabilizer, applied to each side of car, comprising:
a. a cylinder, pivotally connected at one end to a wheel support member, with the second end stabilized by a rod guide;
b. a piston, movably contacting the inside walls of said cylinder, dividing cylinder space into a lower chamber and an upper chamber;
c. a rod attached to said piston on one end, extending through and movably contacted to said rod guide, along at least a portion of its length, and attached to vehicular frame at second end;
d. fittings and tubing attached to said upper and said lower cylinder chambers, with said tubing communicating with opposite chambers on opposite side cylinder.

2. Tubing according to claim 1, comprises distribution valve.

3. Cylinder according to claim 1, wherein cylinder is a shock absorber.

4. A hydraulic leveling system for motorized vehicles comprising fittings and tubing, affixed to automotive shock absorbers, wherein said tubing is configured to direct hydraulic oil from positive pressure side of piston within the cylinder of one shock absorber, to opposite side of piston on the opposite side shock absorber of vehicle, whereas anti-roll properties are applied when turning.
